(19) United States
(12) Patent Application Publication
(10) Pub. No.: US 2015/0005005 A1
(43) Pub. Date: Jan. 1, 2015

(54) LOCATION TRACKING FOR MOBILE TERMINALS AND RELATED COMPONENTS AND METHODS

(71) Applicant: CORNING OPTICAL COMMUNICATIONS LLC, HICKORY, NC (US)

(72) Inventors: Ulrich Wilhelm Heinz Neukirch, Painted Post, NY (US); Michael Sauer, Corning, NY (US)

(21) Appl. No.: 14/486,469

(22) Filed: Sep. 15, 2014

Related U.S. Application Data
(63) Continuation of application No. PCT/US2013/034336, filed on Mar. 28, 2013.
(60) Provisional application No. 61/618,373, filed on Mar. 30, 2012.

(51) Int. Cl. H04W 4/04

(52) U.S. Cl. CPC H04W 4/04
USPC 455/456.1

(57) ABSTRACT

A distributed communications system with a downlink input configured to receive downlink communications signals using a first protocol and a communications interface configured to receive and provide the downlink communications signals to a remote unit. The remote unit has a global positioning device configured to determine location information from satellite signals received from one or more global positioning satellites, and a secondary protocol transmitter configured to provide the location information to a wireless client within an antenna coverage area associated with the remote unit using a secondary protocol.

### PRIORITY APPLICATION

This is a continuation of International Application No. PCT/US2013/034336, filed Mar. 28, 2013, which claims the benefit of priority under 35 U.S.C. §119 of U.S. Provisional Application No. 61/618,373, filed on Mar. 30, 2012, the contents of which are relied upon and incorporated herein by reference in its entirety.

### BACKGROUND

1. Field of the Disclosure

The technology of the disclosure relates to location based systems for tracking locations of mobile terminals, including distributed antenna systems.

2. Technical Background

Wireless communication is rapidly growing, with ever-increasing demands for high-speed mobile data communication. As an example, WiFi systems and wireless local area networks (WLANs) are being deployed in many different types of areas (e.g., coffee shops, airports, libraries, etc.). Distributed communications or antenna systems communicate with wireless devices called “clients,” “client devices,” or “wireless client devices,” which must reside within the wireless range or “cell coverage area” to communicate with an access point device. Distributed antenna systems are particularly useful to be deployed inside buildings or other indoor environments where client devices may not otherwise be able to effectively receive RF signals from a source.

One approach to deploying a distributed communications system involves the use of radio frequency (RF) antenna coverage areas. Antenna coverage areas can have a relatively short range from a few meters up to twenty meters. Because the antenna coverage areas each cover small areas, there are typically only a few users (clients) per antenna coverage area. This allows for minimizing the amount of bandwidth shared among the wireless system users. Use of optical fiber to distribute communication signals includes the benefit of increased bandwidth.

One type of distributed communications system for creating antenna coverage areas, called “Radio-over-Fiber” or “RoF,” utilizes RF signals sent over optical fibers. Such systems can include a head-end station optically coupled to a plurality of remote antenna units that each provides antenna coverage areas. The remote antenna units each include RF transceivers coupled to an antenna to transmit RF signals wirelessly, wherein the remote antenna units are coupled to the head-end station via optical fiber links. The RF transceivers in the remote antenna units are transparent to the RF signals. The remote antenna units convert incoming optical RF signals from the optical fiber link to electrical RF signals via optical-to-electrical (O/E) converters, which are then passed to the RF transceiver. The transceiver converts the electrical RF signals to electromagnetic signals via antennas coupled to the RF transceiver provided in the remote antenna units. The antennas also receive electromagnetic signals (i.e., electromagnetic radiation) from clients in the antenna coverage area and convert them to electrical RF signals (i.e., electrical RF signals in wire). The remote antenna units then convert the electrical RF signals via electrical-to-optical (E/O) converters. The optical RF signals are then sent to the head-end station via the optical fiber link.

The remote antenna units can be distributed throughout locations inside a building to extend wireless communication coverage throughout the building. Other services may be negatively affected or not possible due to the indoor environment. For example, it may be desired or required to provide localization services for a client, such as emergency 911 (E911) services. If the client is located indoors, techniques such as global positioning services (GPS) may not be effective at providing or determining the location of the client. Further, triangulation techniques from the outside network may not be able to determine the location of the client.

### SUMMARY OF THE DETAILED DESCRIPTION

Embodiments disclosed herein include location tracking for mobile terminals, related components, systems, and methods. For example, the systems disclosed herein can provide location information to mobile terminals that may not be able to receive otherwise global positioning system (GPS) information from the GPS satellites, such as, for example, when the mobile terminal does not receive GPS signals from the GPS satellites. Providing location information to clients inside a building or other location may make location based services, such as emergency (E911) services, for example, possible based on the location information.

In one embodiment, a distributed communications system comprises at least one downlink input configured to receive downlink communications signals using a first protocol and at least one communications interface configured to receive and provide the downlink communications signals to a remote unit. The distributed communications system comprises the remote unit, which in turn comprises a global positioning device configured to determine location information from satellite signals received from one or more global positioning satellites, and a secondary protocol transmitter configured to provide the location information to a wireless client within an antenna coverage area associated with the remote unit using a secondary protocol.

In another embodiment, a method to assist in provision of location based services comprises receiving downlink communications signals at at least one downlink input using a first protocol and providing the downlink communications signals to a remote unit. The method comprises intermittently receiving signals from one or more satellites in a global positioning satellite constellation at a device in the remote unit and calculating a location for the remote unit based on the signals from the one or more satellites. The method comprises providing, through a secondary protocol transmitter from the remote unit location, information to a wireless client within an antenna coverage area associated with the remote unit.

As non-limiting examples, the global positioning satellites may be part of the GPS, GLONASS, Galileo or COMPASS satellite systems. In another non-limiting example, the secondary protocol may be a WiFi signal.

The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a schematic diagram of an exemplary optical fiber-based distributed communications system;

FIG. 2 is a block diagram of an exemplary wireless client that may be used in a distributed communications system;

FIG. 3 is a partially schematic cut-away diagram of a building infrastructure in which an optical fiber-based distributed communications system is employed;

FIG. 4 is a stylized depiction of a global positioning satellite system useful for exemplary embodiments of the present disclosure;

FIG. 5 is a block diagram of an exemplary embodiment of a portion of a distributed communications system;

FIG. 6 is a block diagram of a second exemplary embodiment of a portion of a distributed communications system;

FIG. 7 is a flow chart of an exemplary embodiment of a process associated with the present disclosure; and

FIG. 8 is a schematic diagram of a generalized representation of a computer system that can be included in any of the modules provided in the distributed antenna systems described herein.

### DETAILED DESCRIPTION

Reference will now be made in detail to the embodiments, examples of which are illustrated in the drawings, in which some, but not all embodiments are shown. Indeed, the concepts may be embodied in many different forms and should not be construed as limiting herein. Whenever possible, like reference numbers will be used to refer to like components or parts.

Embodiments disclosed herein include location tracking for mobile terminals. Related components, systems, and methods are also disclosed herein. For example, the systems disclosed herein can provide location information to mobile terminals that may not be able to receive otherwise global positioning system (GPS) information from the GPS satellites, such as, for example, when the mobile terminal does not receive GPS signals from the GPS satellites. Providing location information to clients inside a building or other location may make location based services, such as emergency (E911) services, for example, possible based on the location information.

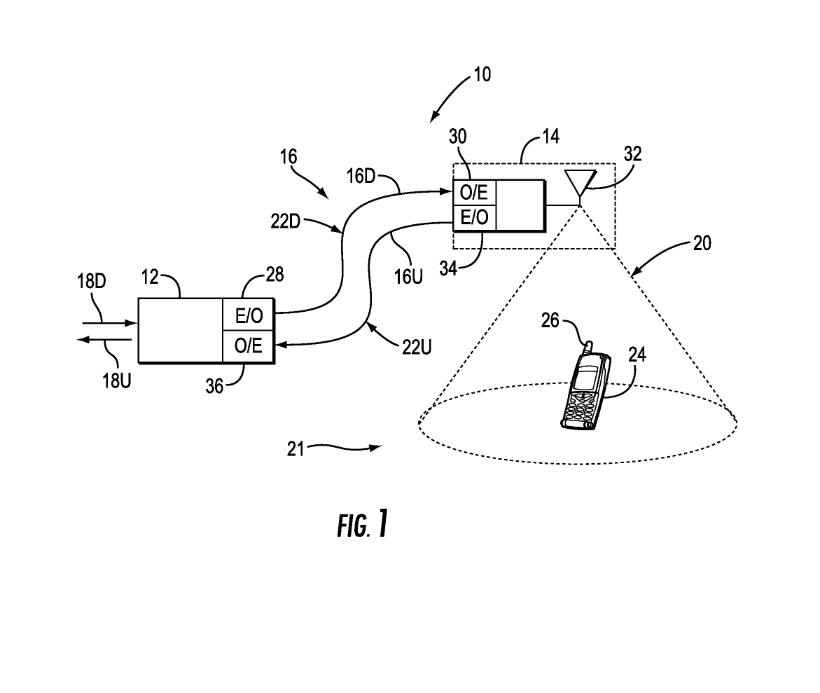

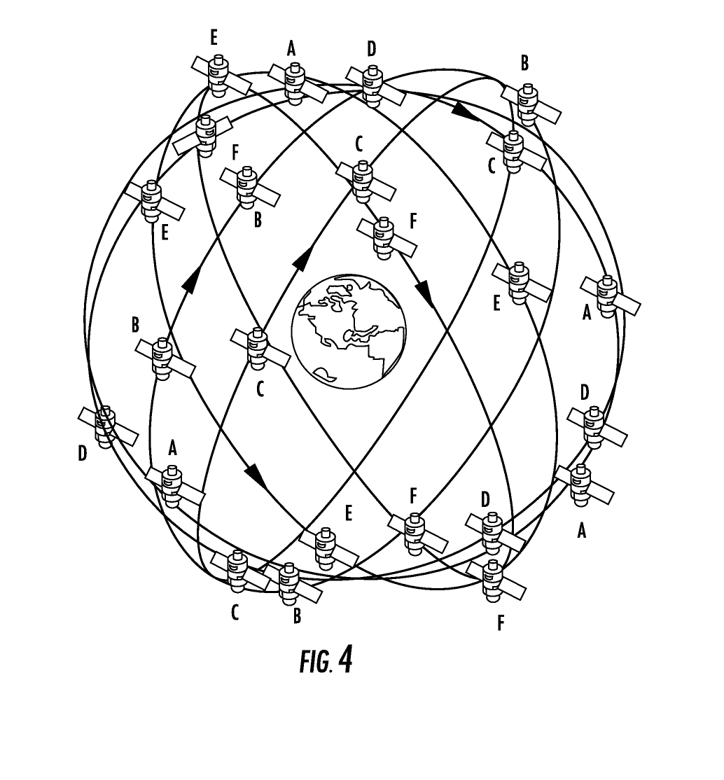

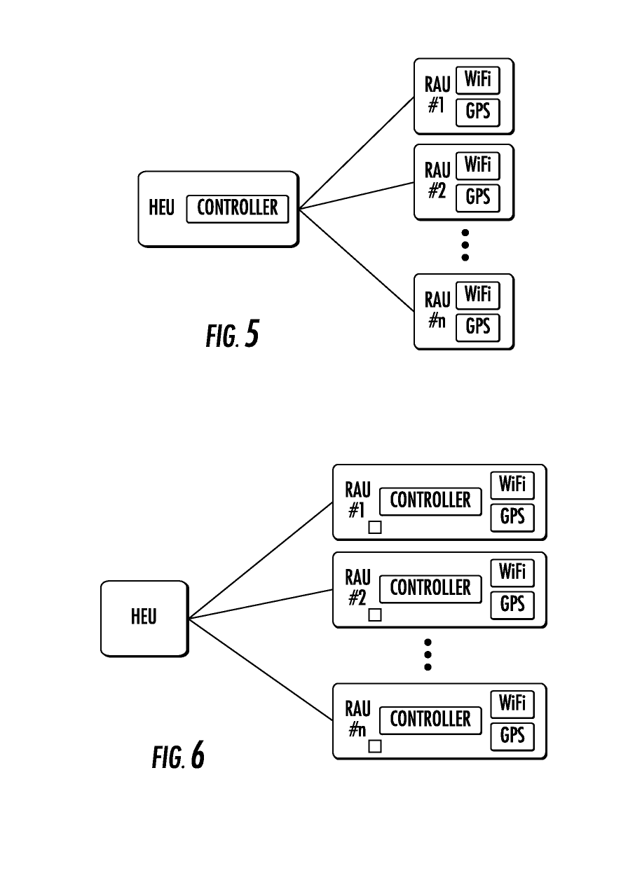

Before discussing systems and methods of providing localization services in a distributed communications system, which starts at FIG. 5, an exemplary generalized optical fiber-based distributed communications is first described with regard to FIGS. 1-3 and a global positioning system is described with regard to FIG. 4.

FIG. 1 is a schematic diagram of a generalized embodiment of an optical fiber-based distributed communications system. In this exemplary embodiment, the system is an optical fiber-based distributed communications system 10 that is configured to create one or more antenna coverage areas for establishing communications with wireless client devices (sometimes referred to herein as mobile terminals) located in the radio frequency (RF) range of the antenna coverage areas. In this regard, the distributed communications system 10 includes head-end equipment, exemplified as a head-end unit or HEU 12, one or more remote antenna units (RAUs) 14 (sometimes referred to herein as a “remote unit”) and an optical fiber 16 that optically couples the HEU 12 to the RAU 14. The HEU 12 is configured to receive communications over downlink electrical RF signals 18D from a source or sources, such as a network or carrier as examples, and provide such communications to the RAU 14. The HEU 12 is also configured to return communications received from the RAU 14, via uplink electrical RF signals 18U, back to the source or sources. In this regard, in this embodiment, the optical fiber 16 includes at least one downlink optical fiber 16D to carry signals communicated from the HEU 12 to the RAU 14 and at least one uplink optical fiber 16U to carry signals communicated from the RAU 14 back to the HEU 12. Note that there are embodiments where both the uplink and downlink signals 18U, 18D are transmitted on the same optical fiber 16, albeit at different frequencies. The present disclosure is operable in both situations.

With continuing reference to FIG. 1, the communications system 10 has an antenna coverage area 20 that can be substantially centered about the RAU 14. The antenna coverage area 20 of the RAU 14 forms an RF coverage area 21. The HEU 12 is adapted to perform or to facilitate any one of a number of Radio-over Fiber (RoF) applications, such as radio-frequency identification (RFID), wireless local-area network (WLAN) communication, or cellular phone service. Shown within the antenna coverage area 20 is a client device 24 in the form of a mobile terminal, which may be a cellular telephone, smart phone, tablet computer, or the like. The client device 24 can be any device that is capable of receiving RF communication signals. The client device 24 includes an antenna 26 (e.g., a wireless card) adapted to receive and/or send electromagnetic RF signals.

With continuing reference to FIG. 1, to communicate the electrical RF signals over the downlink optical fiber 16D to the RAU 14, to in turn be communicated to the client device 24 in the antenna coverage area 20 formed by the RAU 14, the HEU 12 includes an electrical-to-optical (E/O) converter 28. The E/O converter 28 converts the downlink electrical RF signals 18D to downlink optical RF signals 22D to be communicated over the downlink optical fiber 16D. The RAU 14 includes an optical-to-electrical (O/E) converter 30 to convert received downlink optical RF signals 22D back to electrical signals to be communicated wirelessly through an antenna 32 of the RAU 14 to client devices 24 located in the antenna coverage area 20.

With continuing reference to FIG. 1, the antenna 32 is also configured to receive wireless RF communications from client devices 24 in the antenna coverage area 20. The antenna 32 receives wireless RF communications from client devices 24 and communicates electrical RF signals representing the wireless RF communications to an E/O converter 34 in the RAU 14. The E/O converter 34 converts the electrical RF signals into uplink optical RF signals 22U to be communicated over the uplink optical fiber 16U. An O/E converter 36 in the HEU 12 converts the uplink optical RF signals 22U into uplink electrical RF signals, which are then communicated as uplink electrical RF signals 18U back to a network or other source. The client device 24 could be in range of any antenna coverage area 20 formed by a RAU 14.

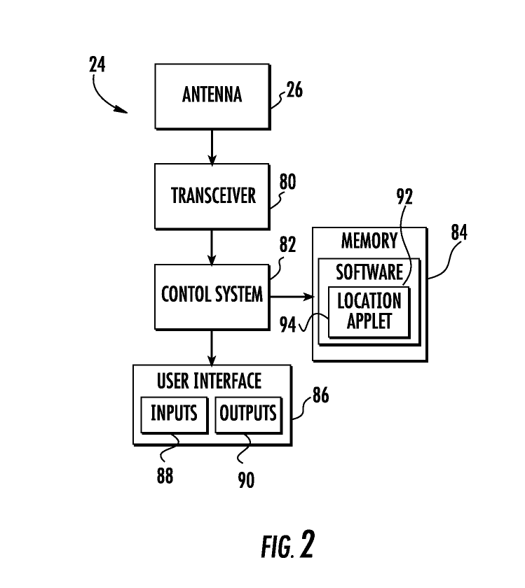

With reference to FIG. 2, a block diagram of a wireless client is provided. The client device 24 may be a wireless client such as a mobile terminal and includes the antenna 26 and a wireless transceiver 80, a control system 82, computer readable memory 84, and a user interface 86. The user interface 86 includes inputs 88 and outputs 90 such as a keypad, touch screen, or the like. The computer readable memory 84 includes software 92 including a location applet 94 which may perform some of the operations of the present disclosure. In an alternate embodiment, the location applet may be stored elsewhere in the client device 24. For example, the location applet may be in the wireless transceiver 80, or within an element such as a digital signal processor (not shown) within the wireless transceiver 80.

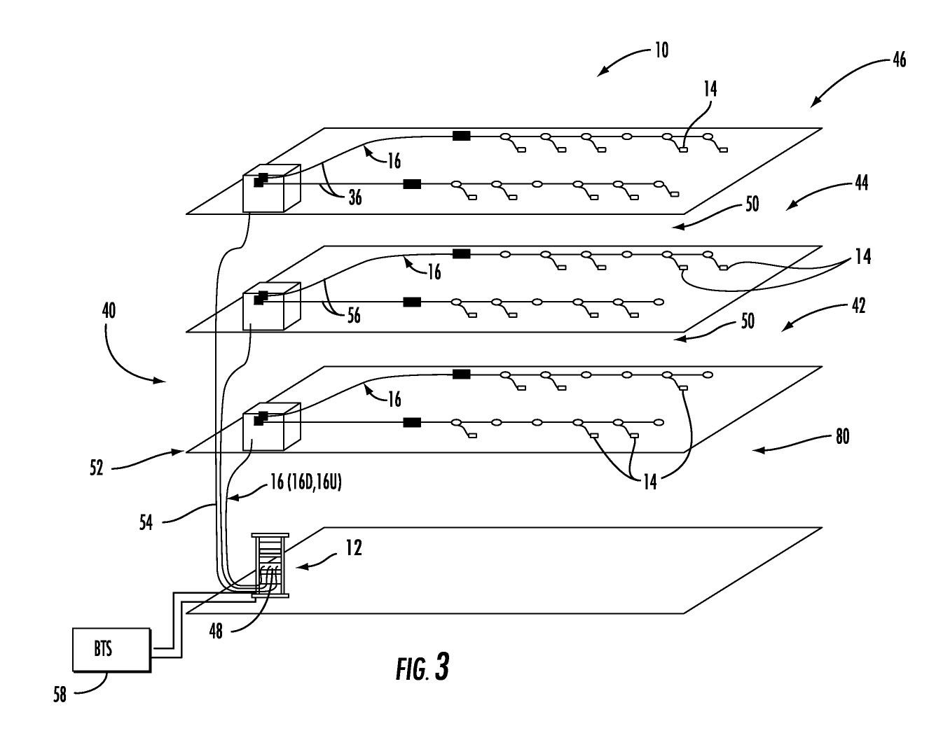

To provide further exemplary illustration of how an optical fiber-based distributed communications system can be deployed indoors, FIG. 3 is a partially schematic cut-away diagram of a building infrastructure 40 employing the optical fiber-based distributed communications system 10 of FIG. 1. The building infrastructure 40 generally represents any type of building in which the distributed communications system 10 can be deployed. As previously discussed with regard to FIG. 1, the optical fiber-based distributed communications system 10 incorporates the HEU 12 to provide various types of communication services to coverage areas within the building infrastructure 40. For example, as discussed in more detail below, the optical fiber-based distributed communications system 10 in this embodiment is configured to receive wireless RF signals and convert the RF signals into RoF signals to be communicated over the optical fiber link 16 to the RAUs 14. The distributed communications system 10 in this embodiment can be, for example, an indoor distributed antenna system (IDAS) to provide wireless service inside the building infrastructure 40. The wireless signals can include, but are not limited to, cellular service, wireless services such as RFID tracking, Wireless Fidelity (WiFi), local area network (LAN), and combinations thereof.

With continuing reference to FIG. 3, the building infrastructure 40 includes a first (ground) floor 42, a second floor 44, and a third floor 46. The floors 42, 44, 46 are serviced by the HEU 12 through a main distribution frame 48, to provide antenna coverage areas 50 in the building infrastructure 40. Only the ceilings of the floors 42, 44, 46 are shown in FIG. 3 for simplicity of illustration. In the example embodiment, a main cable 52 has a number of different sections that facilitate the placement of a large number of RAUs 14 in the building infrastructure 40. Each RAU 14 in turn services its own coverage area in the antenna coverage areas 50. The main cable 52 can include, for example, a riser section 54 that carries all of the downlink and uplink optical fibers 16D, 16U to and from the HEU 12. The main cable 52 can include one or more multi-cable (MC) connectors adapted to connect select downlink and uplink optical fibers 16D, 16U, along with an electrical power line, to a number of optical fiber cables 56.

The main cable 52 enables multiple optical fiber cables 56 to be distributed throughout the building infrastructure 40 (e.g., fixed to the ceilings or other support surfaces of each floor 42, 44, 46) to provide the antenna coverage areas 50 for the first, second, and third floors 42, 44, and 46. In an example embodiment, the HEU 12 is located within the building infrastructure 40 (e.g., in a closet or control room), while in another embodiment the HEU 12 may be located outside of the building infrastructure 40 at a remote location. A base transceiver station (BTS) 58, which may be provided by a second party such as a cellular service provider, is connected to the HEU 12, and can be co-located or located remotely from the HEU 12. A BTS is any station or source that provides an input signal to the HEU 12 and can receive a return signal from the HEU 12. In a typical cellular system, for example, a plurality of BTSs are deployed at a plurality of remote locations to provide wireless telephone coverage. Each BTS serves a corresponding cell and when a mobile terminal enters the cell, the BTS communicates with the mobile terminal. Each BTS includes at least one radio transceiver for enabling communication with one or more subscriber units operating within the associated cell.

FIGS. 1 and 3 are directed to optical fiber implementations, but the present disclosure is not so limited. Rather, any distributed antenna system, wire-based or a hybrid of wire and optical fiber cables or the like, may be used with the exemplary embodiments. Likewise, while FIGS. 1-3 focus on the provision of cellular services and/or the provision of WLAN services “riding” on the fiber network, the present disclosure also is operable with a network that is designed as a WLAN and has a wire-based solution (e.g., twisted pair, CAT5, CAT6, coaxial, pure optical, hybrid (optical and coax), or the like). The present disclosure is likewise operable with composite cabling structures (e.g., DC power wires and fiber strands in a single cable).

FIG. 4 illustrates a stylized depiction of a constellation of global positioning satellites 60, which may sometimes be referred to as a global navigation satellite system (GNSS). The constellation of global positioning satellites 60 is formed from a plurality of satellites 62 (also denoted as A-F in FIG. 4) that orbit the earth in predefined and well understood orbits. The satellites transmit a signal which may be received by terrestrial devices, such as client device 24 (as shown in FIGS. 1 and 2). Normally, the terrestrial device needs signals from three satellites 62 from which the terrestrial device may trilaterate its location. However, the signals from the satellites 62 are typically fairly weak and at frequencies which do not readily penetrate indoors or through other barriers. Exemplary embodiments of the present disclosure allow elements within a distributed communications system 10 to provide location information to the client device 24. Equipped with such location information, the client device 24 can provide that location information when securing E911 services or when other applications on the client device 24 need such location information. While the U.S.-based GPS system is widely known, there are other global positioning satellite systems such as GLONASS, Galileo, and COMPASS. Embodiments of this disclosure may work with any one of these systems, a plurality of these systems concurrently or all of these systems concurrently. The IRIDIUM phone satellite system has proposed offering localization services in the future, and such localization services may be adapted to interoperate with the present disclosure or embodiments of the present disclosure may be adapted to work with the localization signals of the IRIDIUM system. Since the IRIDIUM system may have stronger signal strength (+40 dB) versus the GPS systems, it may feature deeper building penetration.

For most E911 and most other location based services, the client device 24 provides its location information to the provider of the location based services. In some systems, like the uplink time-difference of arrival systems of the Global System for Mobile Communications (GSM), the network may provide the location information, not the handset. As noted above, one of the issues associated with providing location information is ascertaining the location of the client device 24. This issue is exacerbated when the client device 24 is indoors because satellite signals suffer from absorption in building materials. If the client device 24 could receive location information from a distributed communications system 10, the client device 24 could use that information in conjunction with location based services. In many instances, the location based services do not need an extremely fine resolution (e.g., less than one meter) of the location of the client device 24. That is, a reasonably coarse location determination (e.g., within ten to twenty meters) may be sufficient for most location based services. If the RAU 14 (or other access point element associated with the distributed communications system 10) knows its location and can send that location to the client device 24, then the client device 24 can treat the location of the RAU 14 (or other access point element) as the location of the client device 24. However, as noted, satellite signals are not reliable indoors, so it may be difficult for the RAU 14 to learn its location. The present disclosure provides techniques through which the distributed communications system 10 can learn the location of elements within the distributed communications system 10 and convey those locations to proximate client devices 24.

In this regard, FIG. 5 illustrates a first exemplary embodiment of a simplified distributed communications system 70, with HEU 12A and RAUs 14A(1)-14A(N). The HEU 12A has a controller 72 associated therewith that provides a control system with sufficient processing power and the appropriate software to implement aspects of this exemplary embodiment. The RAUs 14A(1)-14A(N) include a respective global positioning device 74(1)-74(N), which may be a chip set with appropriate antenna designed to receive signals from global positioning satellites 60. The RAUs 14A(1)-14A(N) also include a respective secondary protocol transmitter 76(1)-76(N), collectively referred to as secondary protocol transmitters 76. The secondary protocol transmitter 76 operates as WiFi device and uses the WiFi capabilities to communicate with client devices 24. The secondary protocol transmitters 76 communicate with the client devices 24 over a second protocol, which may be different from other protocols used by the RAUs 14A to communicate with the client devices 24. For example, the RAUs 14A may communicate with the client devices 24 using cellular technologies as a first protocol and WiFi as a second protocol. Alternatively, the secondary protocol may be BLUETOOTH, infrared-based, or other technique as desired.

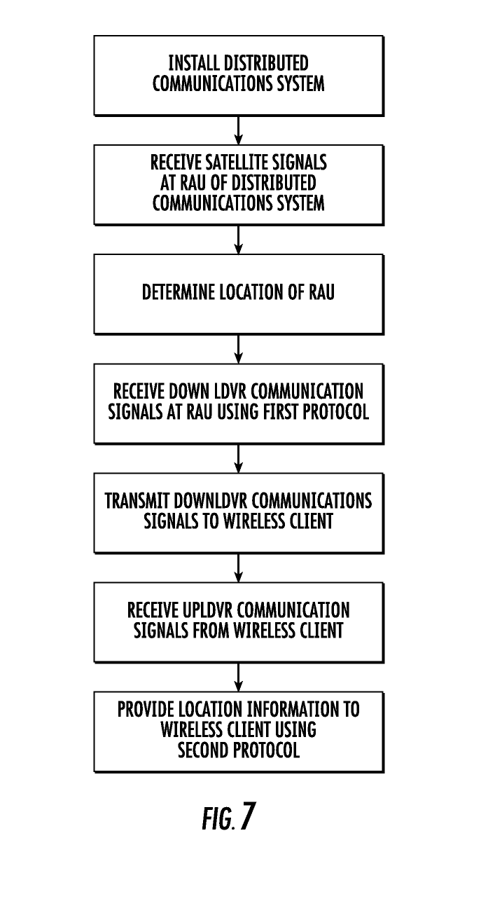

A second exemplary embodiment is illustrated in FIG. 6. In contrast to the embodiment of FIG. 5, the distributed communication system 78 places controllers 96(1)-96(N) in the respective RAUs 14B(1)-14B(N). The HEU 12B communicates with the RAUs 14B(1)-14B(N) as previously described. The RAUs 14B(1)-14B(N) include respective global positioning devices 74B(1)-74B(N) and respective secondary protocol transmitters 76B(1)-76B(N), which are substantially identical to those described above. Additionally, the RAUs 14B(1)-14B(N) may include a respective memory unit 98(1)-98(N) where the location information may be stored. Note that while not illustrated, the RAUs 14A may also include such memory unit. Alternatively, the location information may be stored in a memory unit associated with the HEU 12A, 12B and sent to the RAU 14A, 14B when requested by the client device 24.

The global positioning devices 74 experience the same problems in receiving satellite signals as the client devices 24. That is, the global positioning devices 74 are positioned inside a building which may act to occlude or otherwise attenuate the signals from the satellites 62. However, the fixed positions of the global positioning devices 74 allow for a higher probability that the global positioning devices 74 are able to determine a location of the respective RAU 14A, 14B with reasonable accuracy.

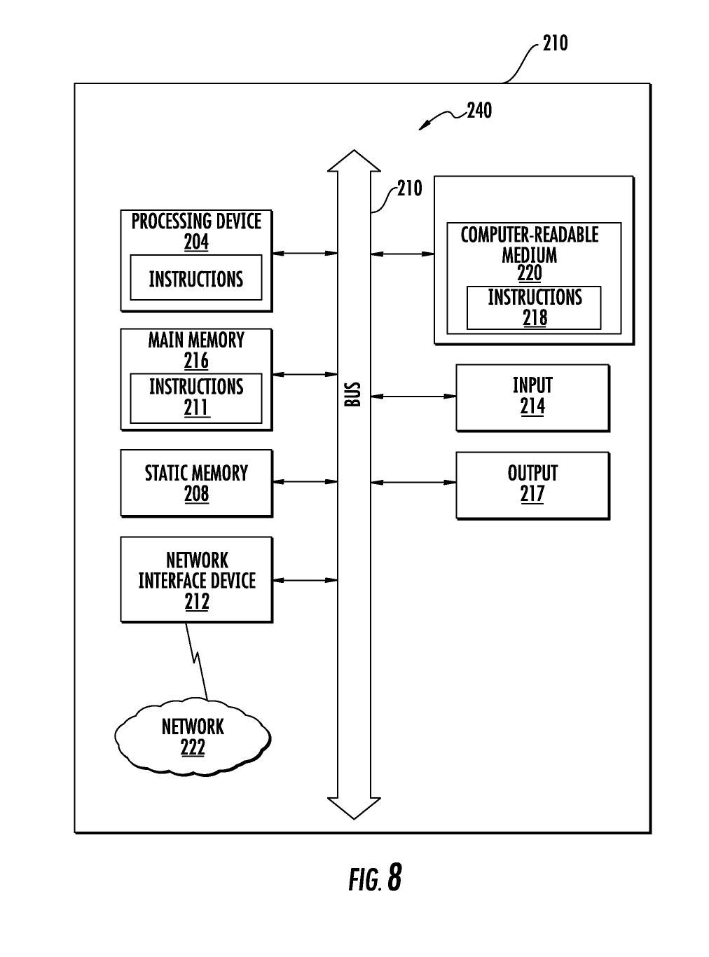

In this regard, FIG. 7 is a flow chart illustrating how the global positioning devices 74 calculate position and how the client devices 24 receive location information. Initially, the distributed communications system 10 is installed (block 100). During the installation, the RAUs 14A or 14B (generically RAU 14) are installed with respective global positioning devices 74. The global positioning devices 74 receive satellite signals (block 102). Since the global positioning devices 74 are stationary, a few minutes of satellite signal availability (whether it be just once, or intermittently) will suffice to provide an actual measurement of the location of the respective RAU 14. That is, because the satellites 62 move, at different times, different ones of the satellites 62 are over the horizon and at different positions relative to the RAU 14. Such variations in relative positioning may allow signals to penetrate the buildings to different degrees (e.g., at a certain angle, a signal passes through a window and down a hallway to the RAU 14). Thus, the controller 72 or other devices may use this measurement to calculate the position of the RAU 14 (block 104). If the global positioning device 74 is compatible with multiple ones of the satellite systems (i.e., GPS, GLONASS, COMPASS, Galileo), then the likelihood of being able to make a meaningful calculation increases as the number of satellites increases. The elevation information (e.g., floor level) may be programmed a priori into the memory units 98 of the respective RAUs 14 during deployment of the distributed communications system 10. The controller may update the location of the RAU 14 based on latest location information and past data, and, depending on quality-of-data information, may use a weighted averaging scheme to calculate the location. Over time, it is expected that the RAU 14 will calculate its position with a high degree of accuracy, in part because the stationary system can also use longer integration times than a mobile system. Longer integration times increases signal sensitivity, which improves accuracy in location determination.

Normally, global positioning systems need three satellites with which to trilaterate to ascertain location. In an alternate embodiment, the controller may use technology developed by Rx Networks Inc. of 1201 W. Pender Street, Suite 800, Vancouver, British Columbia, Canada, V6E 2V2. Rx Networks has developed a system whereby if only two satellites are visible, an algorithm can be applied to ascertain that the solution to the location equations is one of two possible locations on the earth's surface. Using external data, such as coarse location information like cell-sector ID or WiFi-AP ID, the correct one of the two possible locations is determined. Such coarse location information should be readily available since the distributed communication system 10 is deployed in a venue of a generally known geo-location (e.g., street address or the like).

With continuing reference to FIG. 7, once the distributed communications system 10 is deployed, the distributed communications system 10 begins receiving downlink communication signals through the HEU 12 and passing the downlink communication signals to the RAUs 14 using a first protocol, such as a cellular protocol (block 106). The RAUs 14 transmit the downlink communication signals to the client devices 24 (block 108) such as a wireless client or mobile terminal. This transmission may occur using the first protocol or other protocol as desired. Optionally, the distributed communications system 10 may receive uplink communication signals from the client device 24 (block 110). The RAUs 14 may provide location information to the client device 24 using a second protocol (block 112) at the request of the client device 24, periodically, or continuously. As noted above, the location information is calculated by the controller or the global positioning device.

The HEU 12, RAU 14, client device 24 or other devices disclosed herein can include a computer system. FIG. 8 is a schematic diagram representation of additional detail regarding an exemplary computer system 200 adapted to execute instructions from an exemplary computer-readable medium to perform power management functions. The computer system 200 includes a set of instructions for causing the HEU 12, RAU 14, or other device, to perform any one or more of the methodologies discussed herein. The computer system 200 may be connected (e.g., networked) to other machines in a LAN, an intranet, an extranet, or the Internet. The computer system 200 may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The computer system 200 may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server or a user's computer.

The computer system 200 in this embodiment includes a processing device or processor 204, a main memory 216 (e.g., read-only memory (ROM), flash memory, dynamic random access memory (DRAM) such as synchronous DRAM (SDRAM), etc.), and a static memory 208 (e.g., flash memory, static random access memory (SRAM), etc.), which may communicate with each other via the data bus 210. The static memory 208 may correspond to memory 98(1)-98(N) (as shown in FIG. 6). Alternatively, the processing device 204 may be connected to the main memory 216 and/or static memory 208 directly or via some other connectivity means. The processing device 204 may be a controller, and the main memory 216 or static memory 208 may be any type of memory.

The processing device 204 represents one or more general-purpose processing devices such as a microprocessor, central processing unit, or the like. More particularly, the processing device 204 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 204 is configured to execute processing logic in instructions for performing the operations and steps discussed herein.

The computer system 200 may further include a network interface device 212, and may or may not include an input 214 to receive input and selections to be communicated to the computer system 200 when executing instructions. The computer system 200 also may include an output 217, including a display, a video display unit (e.g., a liquid crystal display (LCD) or a cathode ray tube (CRT)), an alphanumeric input device (e.g., a keyboard), and/or a cursor control device (e.g., a mouse).

The computer system 200 may or may not include a data storage device that includes instructions 218 stored in a computer-readable medium 220. The instructions 218 may also reside, completely or at least partially, within the main memory 216 and/or within the processing device 204 during execution thereof by the computer system 200. Main memory 216 and the processing device 204 also constitute computer-readable medium as that term is used herein. The instructions 218 may further be transmitted or received over a network 222 via the network interface device 212.

While the computer-readable medium 220 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing device and that cause the processing device to perform any one or more of the methodologies of the embodiments disclosed herein, and thus includes solid-state memories, optical and magnetic medium, and carrier wave signals.

The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having instructions stored thereon, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.), a machine-readable transmission medium (electrical, optical, acoustical or other form of propagated signals (e.g., carrier waves, infrared signals, digital signals, etc.)), etc.

Unless specifically stated otherwise, discussions utilizing terms such as “processing,” “computing,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The algorithms and displays presented herein are not inherently related to any particular computer or apparatus. Various systems may be used with programs in accordance with the teachings herein, or it may prove convenient to construct more specialized apparatuses to perform the method steps. The embodiments described herein are not described with reference to any particular programming language and a variety of programming languages may be used to implement the embodiments.

The various illustrative logical blocks, modules, circuits, and algorithms described in herein may be implemented as electronic hardware, instructions stored in memory or in another computer-readable medium and executed by a processor or other processing device, or combinations of both. The components of the distributed antenna systems may be employed in any circuit, hardware component, integrated circuit (IC), or IC chip, as examples. Memory may be any type and size of memory and may be configured to store any type of information desired. To clearly illustrate this interchangeability, various illustrative components, blocks, modules, circuits, and steps have been described above generally in terms of their functionality. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

The operational steps described in any of the exemplary embodiments are described to provide examples. The operations described may be performed in different sequences other than the illustrated sequences. Furthermore, operations described in a single operational step may be performed in a number of different steps, and one or more operational steps may be combined. The steps illustrated in flow charts may be subject to numerous different modifications as will be apparent to one of skill in the art. Data, instructions, commands, information, bits, symbols, and chips referenced throughout the above description may be represented by voltages, currents, electromagnetic waves, magnetic fields or particles, optical fields or particles, or any combination thereof.

As used herein, it is intended that the terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. The optical fibers disclosed herein can be single mode or multi-mode optical fibers.

The antenna arrangements disclosed herein may include any type of antenna desired, including but not limited to dipole, monopole, and slot antennas. The distributed antenna systems can include any type or number of communications mediums, including but not limited to electrical conductors, optical fiber, and wireless transmission, and may be configured to transmit and receive any type of communications signals, including RF communications signals and digital data communications signals, as well as multiplexing (e.g., WDM and FDM), examples of which are described in U.S. patent application Ser. No. 12/892,424, entitled “Providing Digital Data Services in Optical Fiber-based Distributed Radio Frequency (RF) Communications Systems, And Related Components and Methods,” incorporated herein by reference in its entirety.

The description and claims are not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A distributed communications system, comprising:
at least one downlink input configured to receive downlink communications signals using a first protocol; and
at least one communications interface configured to receive and provide the downlink communications signals to a remote unit,
the remote unit comprising:
a global positioning device configured to determine location information from satellite signals received from one or more global positioning satellites; and
a secondary protocol transmitter comprising a wireless fidelity (WiFi) protocol transmitter and configured to provide the location information to a wireless client within an antenna coverage area associated with the remote unit using a secondary protocol.

2. The distributed communications system of claim 1, wherein the global positioning device comprises a device compatible with a global satellite system selected from the group consisting of: GPS, GLONASS, Galileo, and COMPASS.

3. The distributed communications system of claim 1, wherein the global positioning device comprises a device compatible with a plurality of global satellite positioning systems.

4. The distributed communications system of claim 3, wherein the plurality of global satellite positioning systems are selected from the group consisting of: GPS, GLONASS, Galileo, and COMPASS.

5. The distributed communications system of claim 1, wherein the distributed communications system comprises a distributed antenna system comprising a plurality of remotes distributed in at least two floors of a building infrastructure, each remote comprising at least one antenna capable of transmitting RF communications into an antenna coverage area.

6. The distributed communications system of claim 5, further comprising at least one optical fiber configured to communicatively couple the at least one communications interface to at least one of the remote units.

7. The distributed communications system of claim 5, further comprising a controller configured to establish a location for the remote unit based on intermittent signals from the one or more global positioning satellites.

8. A distributed communications system deployed in a building infrastructure, comprising:
at least one downlink input configured to receive downlink communications signals using a first protocol; and
at least one communications interface configured to receive and provide the downlink communications signals to at least one of a plurality of remote units distributed in at least two floors of the building infrastructure,
each remote unit comprising:
a global positioning device configured to determine location information from satellite signals received from one or more global positioning satellites; and
a secondary protocol transmitter configured to provide the location information to a wireless client within an antenna coverage area associated with the remote unit using a secondary protocol.

9. The distributed communications system of claim 8, further comprising at least one optical fiber configured to communicatively couple the at least one communications interface to at least one of the remote units.

10. The distributed communications system of claim 9, wherein the global positioning device comprises a device compatible with a global satellite system selected from the group consisting of: GPS, GLONASS, Galileo, and COMPASS.

11. The distributed communications system of claim 9, further comprising a controller configured to establish a location for the remote unit based on intermittent signals from the one or more global positioning satellites.

12. A method to assist in provision of location based services in a distributed communications system, comprising:
receiving downlink communications signals at at least one downlink input using a first protocol;
providing the downlink communications signals to a remote unit;
at least intermittently receiving signals from one or more satellites in a global positioning satellite constellation at a device in the remote unit;
calculating a location for the remote unit based on the signals from the one or more satellites; and
providing through a secondary protocol transmitter comprising a wireless fidelity (WiFi) protocol transmitter from the remote unit location information to a wireless client within an antenna coverage area associated with the remote unit.

13. The method of claim 12, wherein at least intermittently receiving signals from one or more satellites comprises receiving signals from a global satellite system selected from the group consisting of: GPS, GLONASS, Galileo, and COMPASS.

14. The method of claim 12, wherein at least intermittently receiving signals from one or more satellites comprises receiving signals from a plurality of global satellite positioning systems.

15. The method of claim 14, wherein receiving signals from the plurality of global satellite positioning systems comprises receiving signals from a plurality of satellites selected from the group consisting of: GPS, GLONASS, Galileo, and COMPASS.

16. The method of claim 12, wherein the distributed communications system comprises a distributed antenna system comprising a plurality of remote units distributed in at least two floors of a building infrastructure, each remote unit receiving RF communication signals over at least one optical fiber.

17. The method of claim 16, further comprising establishing, using a controller, a location for the remote unit based on intermittent signals from the one or more satellites.

18. The method of claim 17, comprising positioning the controller in a head-end unit.

19. The method of claim 18, comprising positioning the controller in the remote unit.
